(19) United States
(12) Patent Application Publication
(10) Pub. No.: US 2007/0261094 A1
(43) Pub. Date: Nov. 8, 2007

(54) Asymmetrical directional coupler

(76) Inventor: Tibor Urbanek, Britton, MI (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/418,737

(22) Filed: May 5, 2006

(51) Int. Cl. H04N 7/173

(52) U.S. Cl. 725/127; 725/128; 725/126

(57) ABSTRACT

An asymmetrical coupler including first, second, and third diplex filters and first and second directional couplers is described. The first diplex filter is connected with a main input. The first directional coupler is connected with the first diplex filter. The first directional coupler has a first tap with a first value. The second directional coupler is connected with the first diplex filter. The second directional coupler has a second tap with a second value. The second diplex filter is connected with a main output. The second diplex filter is connected with the first and second directional couplers. The third diplex filter is connected with a main tap. The third diplex filter is connected with the first and second directional couplers.

### BACKGROUND

This invention relates generally to directional couplers, and more specifically to an asymmetrical directional coupler designed to deal with a voice over internet protocol (VOIP) and other data signals.

In VOIP or other data and TV transmission applications which are used on a two-way cable television (CATV) system, data is typically transmitted from a base station to an end user carried on a frequency bandwidth of 52-1000 MHz, called the downstream signal. Data which is transmitted from the user to the base station is transmitted on a frequency bandwidth of 5-42 MHz, called the upstream signal. Electronic devices which are connected at the end user or base station ends, such as telephony devices and cable modems, separate and combine the upstream and downstream signals internally as necessary for receiving or sending data carried on these signals.

Initially, two-way CATV communications systems did not transmit VOIP data using the downstream and upstream signals since the signals were only being transmitted for use by computers and televisions sets. Losing power for this form of data transmission was not important since computers and TV sets do not work without power either. However, cable and other companies have started to offer telephones through the cable system using signals which transmit VOIP data. Voice conversation is translated into VOIP data and transmitted the same way as any other computer data, such as through the internet. In order to fully compete with telephone companies, VOIP data transmission must be extremely reliable. One of the weak links in VOIP data transmission is supplying the power to external devices which receive VOIP data. Since the conventional telephone system is powered directly from a main office, the telephones still operate when the electrical power fails. However, in a VoIP telephone system, VOIP devices rely on electrical power received from traditional power companies. When the electrical power fails, a VOIP telephone cannot operate, unlike a traditional telephone. Since everybody is used to telephone working even if power is out, some VOIP devices are equipped with a battery back-up, so that if the electrical power fails in an area, the VOIP device can still operate.

Many cable TV distribution systems consist of amplifiers, coaxial cable, and directional couplers. As illustrated in FIG. 1, a cable TV distribution system 50 may include a coaxial cable 100 connected to an amplifier 102, which is in turn connected to a series of directional couplers 104, 106, 108. Additional amplifiers and directional couplers may be connected in series as needed, such as amplifier 110 and directional coupler 112. In the cable TV distribution system 50, signal levels, tap values, and amplification levels are carefully calculated to deliver a downstream signal at an appropriate level for a subscriber. Each directional coupler 104, 106, 108 includes a respective first, second and third taps 125, 127, 129. Each tap 125, 127, 129 has what is called its own “tap value.” The tap value for a given tap refers to the amount of attenuation given to a signal which travels through that tap. Tap values vary depending on the level of signal available in the system.

As an example, in cable TV distribution systems 50 it may be desirable to deliver a downstream signal having a predetermined signal strength, such as 10 dBmV, to the end user. In order deliver a downstream signal having a predetermined signal strength, the tap values of the taps may have to be selected accordingly. For example, if the amplifier 102 increases the signal strength of the downstream signal to 40 dBmV, if it is determined that the end user needs a downstream signal having a signal strength of 10 dBmV, and if the signal loss due to the coaxial cable 100 between the taps 125, 127, 129 is 5 dBmV, then it is possible to calculate the tap values for each tap 125, 127, 129 in order to deliver a downstream signal having a predetermined signal strength to the end user. In this example, the values for the first tap 125 would be −30 dB (40 dBmV−30 dB=10 dBmV), the value for the second tap would be −25 dB (40 dBmV−5 dBmV−25 dB=10 dBmV), and the value for the third tap 129 would be −20 db (40 dBmV−5 dBmV−5 dBmV−20 dB=10 dBmV).

While it is possible to deliver a downstream signal having a predetermined signal strength to the end user by controlling the tap values, the same cannot be said when dealing with upstream signals from the end user to the base station. In the upstream signal path, where cable and tap losses are much smaller than in the downstream band, problems occur. For example, an upstream signal of 50 dBmV from a first end user traveling through the first tap 125 is attenuated by first tap by −30 dB which creates a signal level of 20 dBmV (50 dBmV−30 dB=20 dBmV) on the coaxial cable 100. This signal level of 20 dBmV may not be high enough to overcome all the losses necessary for the upstream signal to reach the base station or even a closest node.

As illustrated in FIG. 3, in many previous designs of directional couplers 130 used in cable TV distribution systems, a majority of the downstream signal travels from a main input 132 to a main output 134, having a through loss of, for example, 1 dB. A smaller part of the downstream signal is tapped off and travels from the main input 132 to the main tap and is attenuated by the tap value, which may be, for example, 30 dB.

Upstream signals will be traveling through the directional coupler 130 in one of two possible ways: 1) from the main output 134 to the main input 132; and 2) from the main tap 136 to the main input 132. Upstream signals traveling from the main output 134 to the main input 132 will have less through loss, for example 1 dB, than upstream signals traveling from the main tap 136 to the main input 132, which would have a through loss which is determined by the tap value, which could be, for example, 30 dB.

As a result of this design for directional couplers, the attenuation of downstream signal traveling from the main input 132 to the main tap 136 is equal to the attenuation of the upstream signal traveling from the main tap to the main input. It is desirable to have a directional coupler which attenuates downstream signals by an amount which is different than that of which the directional coupler attenuates upstream signals.

### SUMMARY

The present invention is defined by the following claims, and nothing in this section should be taken as a limitation on those claims. By way of introduction, the preferred embodiments described below relate to an asymmetrical coupler having a main input, a main output, and a main tap. The main input receives a downstream signal and transmits upstream signals with a first signal loss and a second signal loss. The main output transmits an upstream signal with a second signal loss and receives a downstream signal with a second signal loss. The main tap for receives a downstream signal with a third signal loss and transmits an upstream signal with a first signal loss. The asymmetrical coupler also includes first, second, and third diplex filters, and first and second directional couplers. The first diplex filter has a first high pass filter, a first low pass filter, and a first input connected with the main input for receiving the downstream signal. The first directional coupler is connected with the first high pass filter. The second directional coupler is connected with the first low pass filter. The second diplex filter has a second high pass filter, a second low pass filter, and a second input connected with the main output. The second high pass filter is connected with the first directional coupler and the second low pass filter is connected with the second directional coupler. The third diplex filter has a third high pass filter, a third low pass filter, and a third input connected with the main tap. The third high pass filter is connected with the first directional coupler and the third low pass filter is connected with the second directional coupler.

The preferred embodiments further relate to a coupler including first, second and third diplex filters and first and second directional couplers. The first diplex filter has a first high pass filter, a first low pass filter, and a first input connected with a main input. The first directional coupler is connected with the first high pass filter. The second directional coupler is connected with the first low pass filter. The second diplex filter has a second high pass filter, a second low pass filter, and a second input connected with a main output. The second high pass filter is connected with the first directional coupler and the second low pass filter is connected with the second directional coupler. The third diplex filter has a third high pass filter, a third low pass filter, and a third input connected with a main tap. The third high pass filter is connected with the first directional coupler and the third low pass filter is connected with the second directional coupler. The coupler further includes a first amplifier connected with the first directional coupler and the second diplex filter.

The preferred embodiments further relate to an asymmetrical coupler including first, second, and third diplex filters and first and second directional couplers. The first diplex filter is connected with a main input. The first directional coupler is connected with the first diplex filter. The first directional coupler has a first tap with a first value. The second directional coupler is connected with the first diplex filter. The second directional coupler has a second tap with a second value. The second diplex filter is connected with a main output. The second diplex filter is connected with the first and second directional couplers. The third diplex filter is connected with a main tap. The third diplex filter is connected with the first and second directional couplers.

### DESCRIPTION OF THE DRAWINGS

FIG. 1 depicts a schematic view of a cable television distribution system.

FIG. 2 depicts a schematic view of a cable television distribution system.

FIG. 3 depicts a schematic view of a tap for use in a cable television distribution system.

FIG. 4 depicts a schematic view of a directional coupler for use in a cable television distribution system, in accordance with one preferred embodiment of the invention.

FIG. 5A depicts a schematic view of a directional coupler for use in a cable television distribution system, in accordance with one preferred embodiment of the invention.

FIG. 5B depicts a schematic view of a directional coupler for use in a cable television distribution system, in accordance with one preferred embodiment of the invention.

FIG. 6 depicts a schematic view of a directional coupler having an amplifier for use in a cable television distribution system, in accordance with one preferred embodiment of the invention.

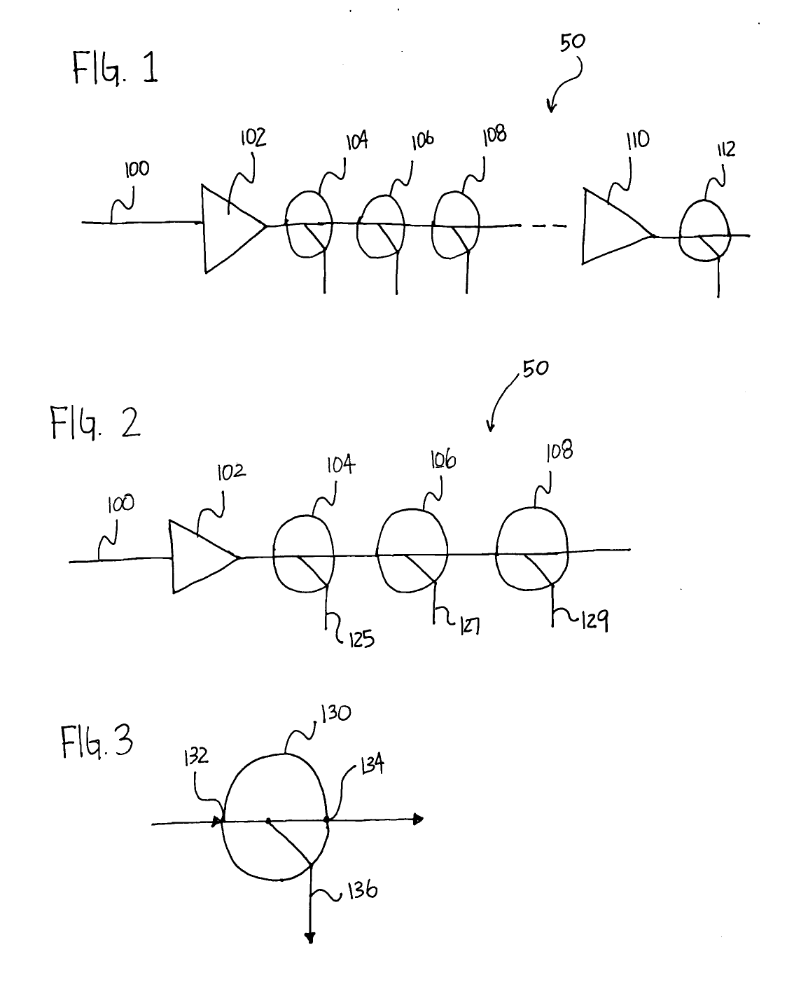

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION

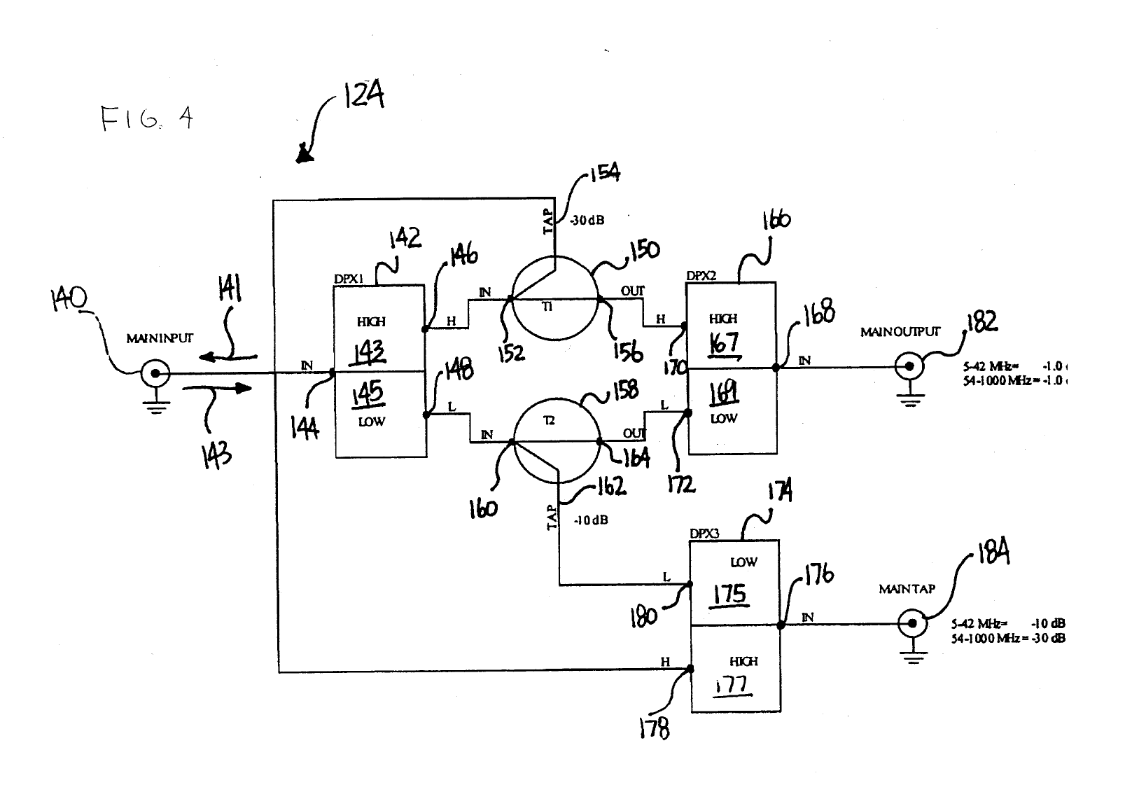

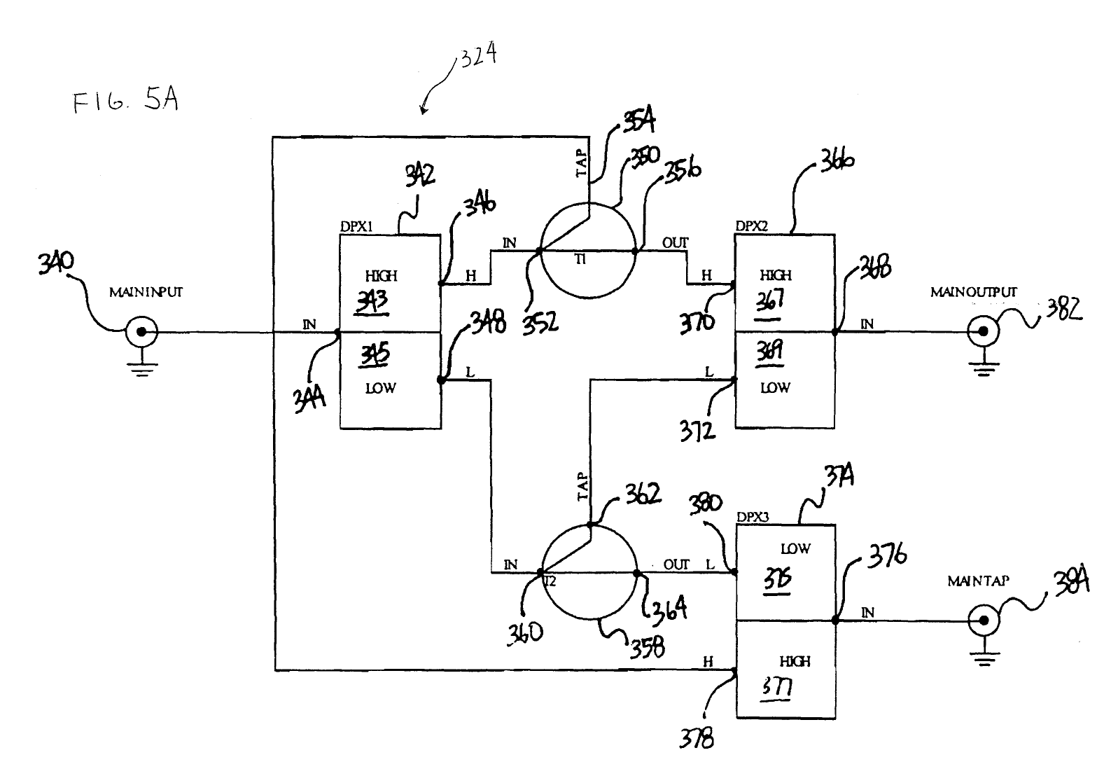

Referring to FIG. 4, there is shown a schematic view of an asymmetrical directional coupler 124, transmitting and routing upstream and downstream signals carrying voiceover internet protocol (VOIP) data over a coaxial cable 100, according to one preferred embodiment. The asymmetrical directional coupler 124 includes a main input 140 for receiving a downstream signal 143 and transmitting upstream signals 141 with a first signal loss and a second signal loss, a main output 182 for transmitting an upstream signal 141 with a second signal loss and receiving a downstream signal 143 with a second signal loss, and a main tap 184 for receiving a downstream signal 143 with a third signal loss and transmitting an upstream signal 141 with a first signal loss. Preferably, the downstream signals are carried on a frequency of about 43 to 2000 megahertz and, more preferably, a frequency of about 52 to 1500 megahertz, and most preferably, a frequency of about 54 to 1000 megahertz. Preferably, the upstream signals are carried on a frequency of about 1 to 500 megahertz and, and more preferably a frequency of about 2 to 45 megahertz, and most preferably, a frequency of about 5 to 42 megahertz.

The asymmetrical directional coupler 124 is able to attenuate downstream signals 143 from the main input 140 to the main output 182 and upstream signals 141 from the main output 182 to the main input 140 so that they both have a signal loss equivalent to a second signal loss. Preferably, the second signal loss is a minimal signal loss having a value of between 0 dB and 10 dB, and more preferably, between 0.1 dB and 2 dB. The asymmetrical directional coupler 124 is able to attenuate downstream signals 143 from the main input 140 to the main tap 184 so that they have a signal loss equivalent to a third signal loss. The asymmetrical directional coupler 124 is able to attenuate upstream signals 141 from the main tap 184 to the main input 140 so that they have a signal loss equivalent to a first signal loss. The first and third signal losses are generally much greater than the second signal losses, since they travel through the main tap 184. Preferably, the first and third signal losses have a value of between 1 dB and 100 dB, and more preferably, between 4 dB and 30 dB. The asymmetrical 124 is designed, as described below, attenuate upstream signals 141 from the main tap 184 to the main input 140 at a different amount from downstream signals 143 traveling from the main input 140 to the main tap 184. Therefore, the first and third signal losses are by design not equivalent to each other. In one embodiment, the third signal loss is greater than the first signal loss. In one embodiment, the third signal loss is less than the first signal loss.

In one embodiment, to accomplish the task of attenuating the downstream signals and the upstream signals traveling through the main tap 184 at different amounts, the asymmetrical directional coupler 124 contains three diplex filters: a first diplex filter 142, a second diplex filter 166, and a third diplex filter 174. Additionally, the asymmetrical directional coupler 124 also contains two directional couplers or taps: a first directional coupler 150 and a second directional coupler 158.

The first diplex filter 142 has a first high pass filter 143, a first low pass filter 145, and a first input connected 144 with the main input 140 for receiving the downstream signal 143. The first high pass filter 143 includes a high pass signal port 146 from which a signal either enters or leaves the first high pass filter 143, and the first low pass filter 145 includes a low pass signal port 148 from which a signal either enters or leaves the first low pass filter 145.

The first directional coupler 150 is connected with the first high pass filter 143. The first directional coupler 150 includes an input 152 which is connected with the high pass signal port 146, a tap 154 which is connected with the third diplex filter 174, and an output 156 which is connected with the second diplex filter 166.

The second directional coupler 158 is connected with the first low pass filter 145. The second directional coupler 158 includes an input 160 which is connected with the low pass signal port 148, a tap 162 which is connected with the third diplex filter 174, and an output 164 which is connected with the second diplex filter 166.

The second diplex filter 166 has a second high pass filter 167, a second low pass filter 169, and a second input 168 connected with the main output 182. The second high pass filter 167 includes a high pass signal port 170 from which a signal either enters or leaves the second high pass filter 167. The high pass signal port 170 is connected with the output 156 of the first directional coupler 150. The second low pass filter 169 includes a low pass signal port 172 from which a signal either enters or leaves the second low pass filter 169. The low pass signal port 172 is connected with the output 164 of the second directional coupler 158.

The third diplex filter 174 has a third high pass filter 177, a third low pass filter 175, and a third input 176 connected with the main tap 184. The third high pass filter 177 includes a high pass signal port 178 from which a signal either enters or leaves the third high pass filter 177. The high pass signal port 178 is connected with the tap 154 of the first directional coupler 150. The third low pass filter 175 includes a low pass signal port 180 from which a signal either enters or leaves the third low pass filter 175. The low pass signal port 180 is connected with the tap 162 of the second directional coupler 158.

In operation, downstream signals 143 traveling from the main input 140 will pass through the first diplex filter 142 from the input 144 through the first high pass filer 143 to the high pass signal port 146. The downstream signal 143 will then enter the first directional coupler 150 at the input 152. A small portion of the downstream signal 143 is tapped off to the tap 154 of the first directional coupler 150. Preferably, the downstream signal 143 tapped off to the tap 154 is decreased by the value of 1 to 50 dB, and preferable by 6-30 dB. Upon passing through tap 154, the downstream signal 143 is then fed into the high pass signal port 178 of the third diplex filter 174. The third diplex filter 174 will pass the downstream signal 143 from the high pass signal port 178 to the input 176 and then onto the main tap 184. The overall attenuation of the downstream signal 143 from the main input 140 to the main tap 184 will be a sum of all losses including the losses from passing through the first diplex filter 142, the first directional coupler 150, and the third diplex filter 174. Preferably, the overall attenuation of the downstream signal 143 from the main input 140 to the main tap 184 is between 1-50 dB, and preferably between 6-30 dB.

The majority of the downstream signal 143 that enters the first directional coupler 150 exists through the output 156 suffering a minimal signal loss or attenuation of, for example, less than 10 dB, and preferably, less than 5 dB, and most preferably, about 1 dB. The downstream signal 143, upon exiting from the output 156, enters the high pass signal port 170 of the second diplex filter 166. The second diplex filter 166 will only allow the downstream signal 143 to pass from the high pass signal port 170 to the input 168 and then to the main output 182. The overall attenuation of the downstream signal 143 from the main input 140 to the main output 182 will be a sum of all losses including the losses from passing through the first diplex filter 142, the first directional coupler 150, and the second diplex filter 166. Preferably, the overall attenuation of the downstream signal 143 from the main input 140 to the main output 182 is as low as possible, and preferably less than or equal to about 1 dB, and most preferably, greater than 0 dB but less than 10 dB.

Upstream signals 141 will be traveling in two different directions: 1) from the main output 182 to the main input 141, and 2) from the main tap 184 to the main input 141. Upstream signals 141 traveling from the main output 182 will enter the second diplex filter 166 through the input 168. The second diplex filter 166 will only allow the upstream signal 141 to pass from the input 168 to the low pass signal port 172. The upstream signal 141 will then travel to the output 164 of the second directional coupler 158, as illustrated in FIG. 4. The upstream signal 141 then travels from the output 164 through the second directional coupler 158 to the input 160 of the second directional coupler 158. The second directional coupler 158 prevents the upstream signal 141 from traveling from the output 164 to the tap 162 of the second directional coupler 158. The upstream signal 141 then travels to the low pass signal port 148 of the first diplex filter 142. The first diplex filter 142 will only allow the upstream signal 141 to pass from the low pass signal port 148 to input 144 of the first diplex filter 142 and then to the main input 140.

The overall attenuation of the upstream signal 141 from the main output 182 to the main input 140 will be a sum of all losses including the losses from passing through the second diplex filter 166, the second directional coupler 158, and the first diplex filter 142. Preferably, the overall attenuation of the upstream signal 141 from the main output 182 to the main input 142 is as low as possible, and preferably less than or equal to about 1 dB, and most preferably, greater than 0 dB but less than 10 dB.

Upstream signal 141 traveling from the main tap 184 to the main input 140 will first enter the third diplex filter 174 through the input 176. The third diplex filter 174 will only allow the upstream signal 141 to travel from the input 176 to the low pass signal port 180. The upstream signal 141 will then travel from the low pass signal port 180 to the tap 162 of the second directional coupler 158. Upon reaching the tap 162, the upstream signal 141 then travels through the second directional coupler 158 from the tap 162 to the input 160 of the second directional coupler 158 and will be attenuated by the value of the second directional coupler 158, which may be, for example, between 5 and 30 dB, and preferably about 10 dB. The second directional coupler 158 prevents upstream signal 141 from traveling from the tap 162 to the output 164 of the second directional coupler 158. Upstream signals 141 will then travel from the input 160 of the second directional coupler 158 to the low pass signal port 148 of the first diplex filter 142. The first diplex filter 142 will only allow the high pass signal 141 entering the low pass signal port 148 to pass from the low pass signal port 148 to the input 144 of the first diplex filter 142, and then onto the main input 140.

The overall attenuation of the upstream signal 141 from the main tap 184 to the main input 140 will be a sum of all losses including the losses from passing through the third diplex filter 174, the second directional coupler 158, and the first diplex filter 142. Preferably, the overall attenuation of the upstream signal 141 from the main tap 184 to the main input 140 is greater than 5 and less than 30 dB, and preferably greater than or equal to about 10 dB, and most preferably, greater than 5 dB but less than 20 dB.

As a result of this design the attenuation of downstream signal 143 traveling from the main input 140 the main tap 184 is not equal to the attenuation of the upstream signal 143 traveling from the main tap 184 to the main input 140. The design of the asymmetrical directional coupler 124 allows for it to attenuate downstream signals 143 by an amount which is different than that of which the directional coupler attenuates upstream signals 143.

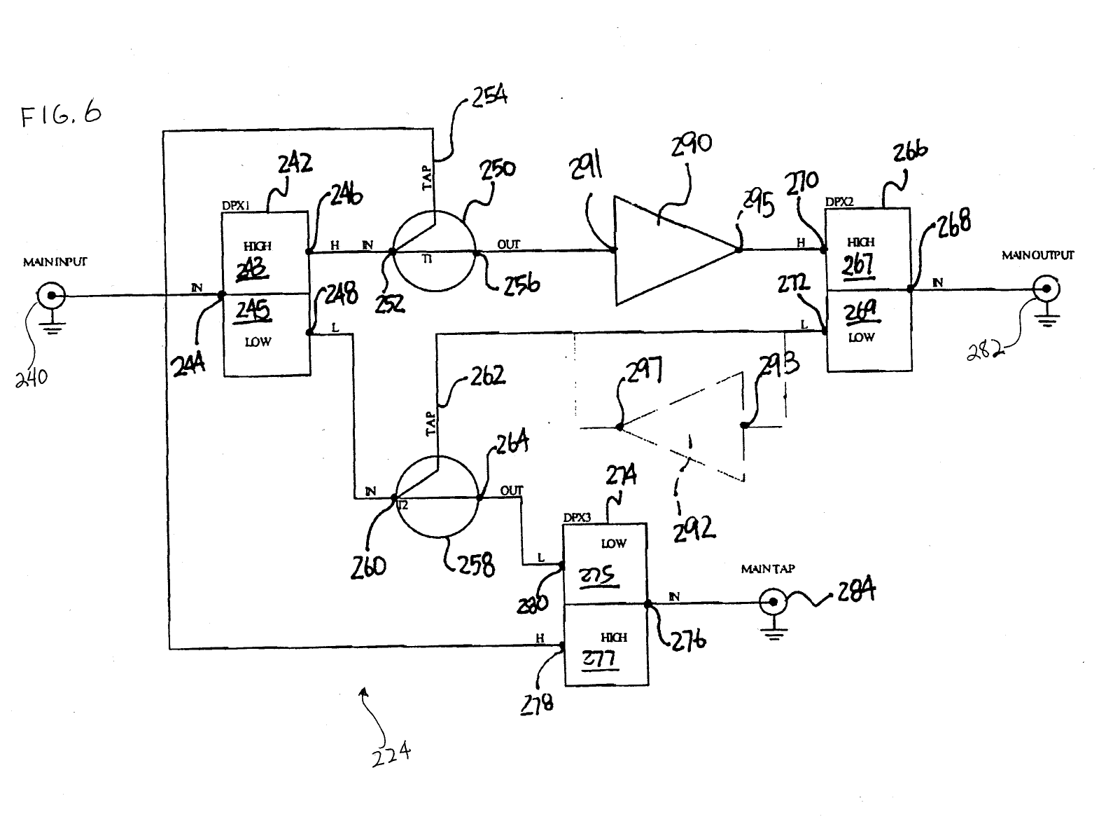

In another embodiment, an asymmetrical coupler 224 is provided, as illustrated in FIG. 6. Asymmetrical coupler 224 has elements which are identical to those of elements in the asymmetrical coupler 124 have referenced numbers which have been increased by 100 over those for element in the asymmetrical coupler 124. The asymmetrical directional coupler 224 contains three diplex filters: a first diplex filter 242, a second diplex filter 266, and a third diplex filter 274 and two directional couplers or taps: a first directional coupler 250 and a second directional coupler 258.

Additionally, the asymmetrical coupler 224 also includes a first amplifier 290 located between and connected with the second diplex filter 266 and the first directional coupler 250. Optionally, the asymmetrical coupler 224 may include a second amplifier 292 located between and connected with the second diplex filter 266 and the second directional coupler 262. The first amplifier 290 is used to amplify the downstream signal 143 traveling from the main input 240 to the main output 282. The second amplifier 292 is used to amplify the upstream signal 141 from the main output 282 to the main input 240.

The first diplex filter 242 has a first high pass filter 243, a first low pass filter 245, and a first input connected 244 with the main input 240 for receiving the downstream signal 243. The first high pass filter 243 includes a high pass signal port 246 from which a signal either enters or leaves the first high pass filter 243, and the first low pass filter 245 includes a low pass signal port 248 from which a signal either enters or leaves the first low pass filter 245.

The first directional coupler 250 is connected with the first high pass filter 243. The first directional coupler 250 includes an input 252 which is connected with the high pass signal port 246, a tap 254 which is connected with a high pass signal port 278 of the third diplex filter 274, and an output 256 which is connected with an input 291 of the first amplifier 290.

The second directional coupler 258 is connected with the first low pass filter 245. The second directional coupler 258 includes an input 260 which is connected with the low pass signal port 248, a tap 262 which is connected with the second diplex filter 266, and an output 264 which is connected with the a low pass signal port 280 of the third diplex filter 274. Optionally, the tap 262 is connected with an output 297 of the second amplifier 292.

The second diplex filter 266 has a second high pass filter 267, a second low pass filter 269, and a second input 268 connected with the main output 282. The second high pass filter 267 includes a high pass signal port 270 from which a signal either enters or leaves the second high pass filter 267. The high pass signal port 270 is connected with an output 295 of the first amplifier 290. The second low pass filter 269 includes a low pass signal port 272 from which a signal either enters or leaves the second low pass filter 269. The low pass signal port 272 is connected with the tap 262 of the second directional coupler 258. Optionally, the low pass signal port 272 is connected with an input 293 of the second amplifier 292.

The third diplex filter 274 has a third high pass filter 277, a third low pass filter 275, and a third input 276 connected with the main tap 284. The third high pass filter 277 includes a high pass signal port 278 from which a signal either enters or leaves the third high pass filter 277. The high pass signal port 278 is connected with the tap 254 of the first directional coupler 250. The third low pass filter 275 includes a low pass signal port 280 from which a signal either enters or leaves the third low pass filter 275. The low pass signal port 280 is connected with an output 264 of the second directional coupler 258.

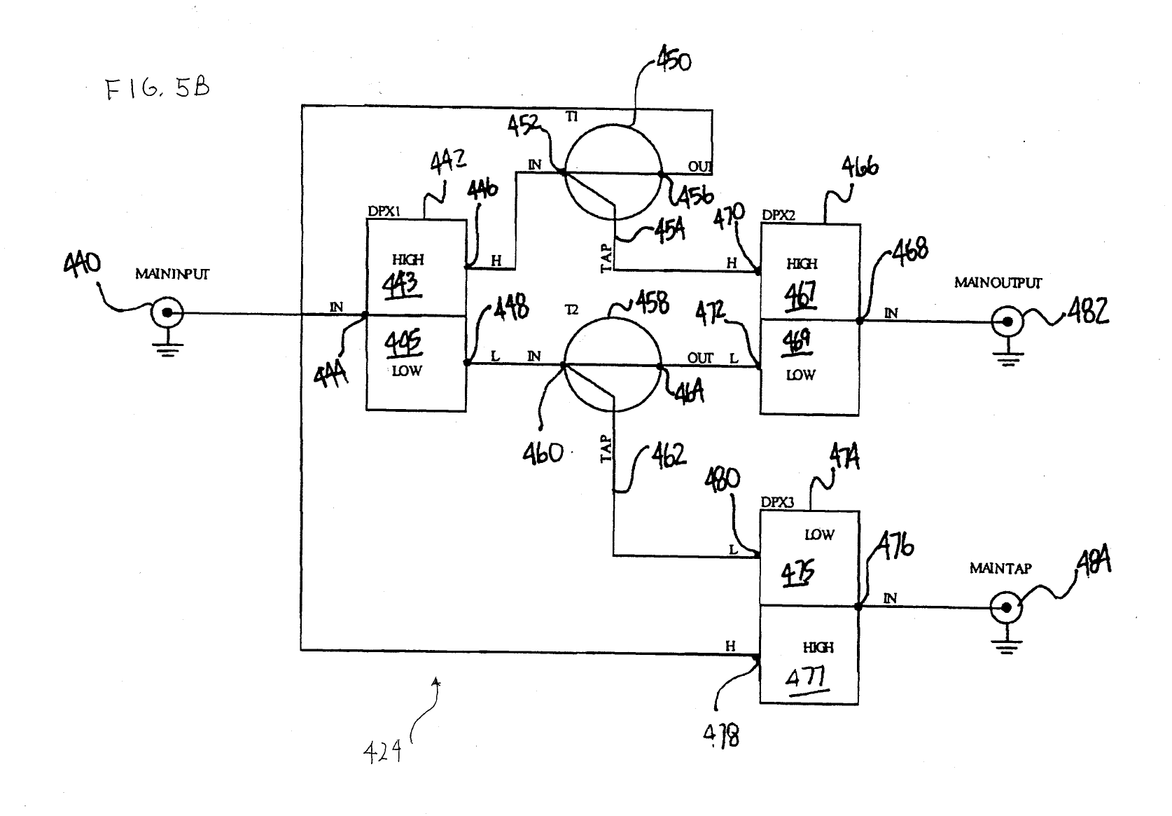

In another embodiment, an asymmetrical coupler 324 with an alternative design is provided, as illustrated in FIG. 5A. Asymmetrical coupler 324 has elements which are identical to those of elements in the asymmetrical coupler 124 have referenced numbers which have been increased by 200 over those for element in the asymmetrical coupler 124. The asymmetrical directional coupler 324 contains three diplex filters: a first diplex filter 342, a second diplex filter 366, and a third diplex filter 374 and two directional couplers or taps: a first directional coupler 350 and a second directional coupler 358.

The first diplex filter 342 has a first high pass filter 343, a first low pass filter 345, and a first input connected 344 with the main input 340 for receiving the downstream signal 343. The first high pass filter 343 includes a high pass signal port 346 from which a signal either enters or leaves the first high pass filter 343, and the first low pass filter 345 includes a low pass signal port 348 from which a signal either enters or leaves the first low pass filter 345.

The first directional coupler 350 is connected with the first high pass filter 343. The first directional coupler 350 includes an input 352 which is connected with the high pass signal port 346, a tap 354 which is connected with a high pass signal port 378 of the third diplex filter 374, and an output 356 which is connected with a high pass signal port 370 of the second diplex filter 366.

The second directional coupler 358 is connected with the first low pass filter 345. The second directional coupler 358 includes an input 360 which is connected with the low pass signal port 348, a tap 362 which is connected with a low pass signal port 372 of the second diplex filter 366, and an output 364 which is connected with a low pass signal port 380 of the third diplex filter 374.

The second diplex filter 366 has a second high pass filter 367, a second low pass filter 369, and a second input 368 connected with the main output 382. The second high pass filter 367 includes a high pass signal port 370 from which a signal either enters or leaves the second high pass filter 367. The high pass signal port 370 is connected with the output 356 of the first directional coupler 350. The second low pass filter 369 includes a low pass signal port 372 from which a signal either enters or leaves the second low pass filter 369. The low pass signal port 372 is connected with the tap 362 of the second directional coupler 358.

The third diplex filter 374 has a third high pass filter 377, a third low pass filter 375, and a third input 376 connected with the main tap 384. The third high pass filter 377 includes a high pass signal port 378 from which a signal either enters or leaves the third high pass filter 377. The high pass signal port 378 is connected with the tap 354 of the first directional coupler 350. The third low pass filter 375 includes a low pass signal port 380 from which a signal either enters or leaves the third low pass filter 375. The low pass signal port 380 is connected with an output 364 of the second directional coupler 358.

In another embodiment, an asymmetrical coupler 424 with an alternative design is provided, as illustrated in FIG. 5B. Asymmetrical coupler 424 has elements which are identical to those of elements in the asymmetrical coupler 124 have referenced numbers which have been increased by 300 over those for element in the asymmetrical coupler 124. The asymmetrical directional coupler 424 contains three diplex filters: a first diplex filter 442, a second diplex filter 466, and a third diplex filter 474 and two directional couplers or taps: a first directional coupler 450 and a second directional coupler 458.

The first diplex filter 442 has a first high pass filter 443, a first low pass filter 445, and a first input connected 444 with the main input 440 for receiving the downstream signal 443. The first high pass filter 443 includes a high pass signal port 446 from which a signal either enters or leaves the first high pass filter 443, and the first low pass filter 445 includes a low pass signal port 448 from which a signal either enters or leaves the first low pass filter 445.

The first directional coupler 450 is connected with the first high pass filter 443. The first directional coupler 450 includes an input 452 which is connected with the high pass signal port 446, a tap 454 which is connected with a high pass signal port 478 of the second diplex filter 466, and an output 456 which is connected with a high pass signal port 478 of the third diplex filter 474.

The second directional coupler 458 is connected with the first low pass filter 445. The second directional coupler 458 includes an input 460 which is connected with the low pass signal port 448, a tap 462 which is connected with a low pass signal port 472 of the third diplex filter 474, and an output 464 which is connected with a low pass signal port 472 of the second diplex filter 466.

The second diplex filter 466 has a second high pass filter 467, a second low pass filter 469, and a second input 468 connected with the main output 482. The second high pass filter 467 includes a high pass signal port 470 from which a signal either enters or leaves the second high pass filter 467. The high pass signal port 470 is connected with the tap 454 of the first directional coupler 450. The second low pass filter 469 includes a low pass signal port 472 from which a signal either enters or leaves the second low pass filter 469. The low pass signal port 472 is connected with the output 464 of the second directional coupler 458.

The third diplex filter 474 has a third high pass filter 477, a third low pass filter 475, and a third input 476 connected with the main tap 484. The third high pass filter 477 includes a high pass signal port 478 from which a signal either enters or leaves the third high pass filter 477. The high pass signal port 478 is connected with the output 456 of the first directional coupler 450. The third low pass filter 475 includes a low pass signal port 480 from which a signal either enters or leaves the third low pass filter 475. The low pass signal port 480 is connected with the tap 462 of the second directional coupler 458.

Although the invention has been described and illustrated with reference to specific illustrative embodiments thereof, it is not intended that the invention be limited to those illustrative embodiments. Those skilled in the art will recognize that variations and modifications can be made without departing from the spirit of the invention.

1. An asymmetrical coupler comprising:
a main input for receiving a downstream signal and transmitting upstream signals with a first signal loss and a second signal loss;
a main output for transmitting an upstream signal with a second signal loss and receiving a downstream signal with a second signal loss;
a main tap for receiving a downstream signal with a third signal loss and transmitting an upstream signal with a first signal loss;
a first diplex filter having a first high pass filter, a first low pass filter, and a first input connected with the main input for receiving the downstream signal;
a first directional coupler connected with the first high pass filter;
a second directional coupler connected with the first low pass filter;
a second diplex filter having a second high pass filter, a second low pass filter, and a second input connected with the main output, wherein the second high pass filter is connected with the first directional coupler and the second low pass filter is connected with the second directional coupler; and
a third diplex filter having a third high pass filter, a third low pass filter, and a third input connected with the main tap, wherein the third high pass filter is connected with the first directional coupler and the third low pass filter is connected with the second directional coupler.

2. The asymmetrical coupler of claim 1, wherein the downstream signal is between 43 and 2000 MHz.

3. The asymmetrical coupler of claim 1, wherein the first signal loss is between 0.1 and 5 dB and the second signal loss is between 5 and 50 dB.

4. The asymmetrical coupler of claim 1, wherein the first directional coupler comprises an input connected with the first high pass filter, an output connected with the second high pass filter, and a tap connected with the third high pass filter.

5. The asymmetrical coupler of claim 1, wherein the second directional coupler comprises an input connected with the first low pass filter, an output connected with the second low pass filter, and a tap connected with the third low pass filter.

6. The asymmetrical coupler of claim 1, wherein the first directional coupler comprises an input connected with the first high pass filter, an output connected with the third high pass filter, and a tap connected with the second high pass filter.

7. The asymmetrical coupler of claim 1, wherein the second directional coupler comprises an input connected with the first low pass filter, an output connected with the third low pass filter, and a tap connected with the second low pass filter.

8. A coupler comprising:
a first diplex filter having a first high pass filter, a first low pass filter, and a first input connected with a main input;
a first directional coupler connected with the first high pass filter;
a second directional coupler connected with the first low pass filter;
a second diplex filter having a second high pass filter, a second low pass filter, and a second input connected with a main output, wherein the second high pass filter is connected with the first directional coupler and the second low pass filter is connected with the second directional coupler; and
a third diplex filter having a third high pass filter, a third low pass filter, and a third input connected with a main tap, wherein the third high pass filter is connected with the first directional coupler and the third low pass filter is connected with the second directional coupler; and
a first amplifier connected with the first directional coupler and the second diplex filter.

9. The coupler of claim 8, wherein an input of the first amplifier is connected with an output of the first directional coupler, and an output of the first amplifier is connected with the second high pass filter.

10. The coupler of claim 8 further comprising a second amplifier connected with the second directional coupler and the second diplex filter.

11. The coupler of claim 10, wherein an output of the second amplifier is connected with a tap of the second directional coupler, and an output of the second amplifier is connected with the second low pass filter.

12. The asymmetrical coupler of claim 8, wherein the first directional coupler comprises an input connected with the first high pass filter, an output connected with the second high pass filter, and a tap connected with the third high pass filter.

13. The asymmetrical coupler of claim 8, wherein the second directional coupler comprises an input connected with the first low pass filter, an output connected with the second low pass filter, and a tap connected with the third low pass filter.

14. The asymmetrical coupler of claim 8, wherein the first directional coupler comprises an input connected with the first high pass filter, an output connected with the third high pass filter, and a tap connected with the second high pass filter.

15. An asymmetrical coupler comprising:
a first diplex filter connected with a main input;
a first directional coupler connected with the first diplex filter, wherein the first directional coupler has a first tap with a first value;
a second directional coupler connected with the first diplex filter, wherein the second directional coupler has a second tap with a second value;
a second diplex filter connected with a main output, wherein the second diplex filter is connected with the first and second directional couplers; and
a third diplex filter connected with a main tap, wherein the third diplex filter is connected with the first and second directional couplers.

16. The asymmetrical coupler of claim 15, wherein the first value is greater than the second value.

17. The asymmetrical coupler of claim 15, wherein the first directional coupler comprises an input connected with the first diplex filter, an output connected with the second diplex filter, and a tap connected with a third diplex filter.

18. The asymmetrical coupler of claim 15, wherein the second directional coupler comprises an input connected with the first diplex filter, an output connected with the second diplex filter, and a tap connected with the third diplex filter.

19. The asymmetrical coupler of claim 15, wherein the first directional coupler comprises an input connected with the first diplex filter, an output connected with the third diplex filter, and a tap connected with the second diplex filter.

20. The asymmetrical coupler of claim 15 further comprising an amplifier connected with the first directional coupler and the second diplex filter.
